(19) United States
(12) Patent Application Publication
(10) Pub. No.: US 2023/0417569 A1
(43) Pub. Date: Dec. 28, 2023

(54) Updating Map Data With User-Generated Image Data

(71) Applicants: Subhasish ROY, Telangana (IN); Google LLC, Mountain View, CA (US)

(72) Inventor: Subhasish Roy, Hyderabad (IN)

(21) Appl. No.: 17/782,235

(22) PCT Filed: Aug. 23, 2021
(86) PCT No.: PCT/US2021/047114

§ 371 Date: Mar. 2, 2023

(51) Int. Cl. G01C 21/00

(52) U.S. Cl. CPC G01C 21/3811; G01C 21/3833; G01C 21/3889

(57) ABSTRACT

The technology relates to updating map data of a mapping service. A mapping service may receive permission to contribute image data captured by a user to the map service. The image data may be uploaded to the map service by a backend service. The map service may provide a recommendation to the backend service including an identification of points of interest in the map data that the image data corresponds to, or an indication that no points of interest were found within the map data that correspond with the image data. The backend service may request the selection of a points of interest the image corresponds to when the recommendation includes one or more points, or request permission from the user to add a new point of interest to the map data.

### BACKGROUND

The process for updating or creating map data by an end-user typically requires the end user to access a map application or website offered by the mapping service that maintains the map data. For instance, to create an entry for a point of interest not present in the map data, a user is typically required to open a mapping application before manually navigating to the portion of the map application where the user may submit the new entry to the map data. Similarly, when a user wants to add map data to an existing point of interest, the user needs to search for that point of interest in the app and then complete an additional process for adding the map data to the point of interest. The known ways of adding map data to an existing point of interest and creating a new entry for a point of interest are error-prone. For instance, when adding map data to an existing point of interest, there is a significant chance the user will add map data to the wrong point of interest. Likewise, when creating a new entry in the map data, there is a considerable chance the user will create a new entry in the map data even though the point of interest already exists in the map data. As a result, the map data may be incorrect and duplicative.

### SUMMARY

Aspects of this disclosure are directed to a backend service for updating map data maintained by a mapping service with user-generated content. One aspect of the disclosure is directed to a method for updating map data of a mapping service, The method includes capturing, by a computing device, an image of a point of interest, the image including image data; generating, by a service executing on the computing device, a notification through a notification microservice, the notification requesting permission to contribute the image data to a map service; after receiving permission to contribute the image data to the map service, transmitting, by the service, the image data to a map service; receiving, by the service from the map service, a recommendation, wherein the recommendation includes: (i) one or more points of interest in the map data that the image data corresponds to, or (ii) an indication that no points of interest were found within the map data that correspond with the image data; and generating, by the service, a notification, wherein the notification: (i) requests the selection of one of the one or more points of interest in recommendation, or (ii) requests permission from the user to add a new point of interest to the map data.

Another aspect of the disclosure is directed to a system. The system may include one or more processors configured to: capture an image of a point of interest, the image including image data; generate, by a service, a notification through a notification microservice, the notification requesting permission to contribute the image data to a map service; after receiving permission to contribute the image data to the map service, transmit by the service, the image data to a map service; receive, by the service from the map service, a recommendation, wherein the recommendation includes: (i) one or more points of interest in the map data that the image data corresponds to, or (ii) an indication that no points of interest were found within the map data that correspond with the image data; and generate, by the service, a notification, wherein the notification:

(i) requests the selection of one of the one or more points of interest in recommendation, or (ii) requests permission from the user to add a new point of interest to the map data.

Another aspect of the disclosure is directed to a non-transitory computer-readable storage medium storing instructions executable by one or more processors for performing a method. The method may include capturing an image of a point of interest, the image including image data; generating, by a service, a notification through a notification microservice, the notification requesting permission to contribute the image data to a map service; after receiving permission to contribute the image data to the map service, transmitting by the service, the image data to a map service; receiving, by the service from the map service, a recommendation, wherein the recommendation includes: (i) one or more points of interest in the map data that the image data corresponds to, or (ii) an indication that no points of interest were found within the map data that correspond with the image data; and generating, by the service, a notification, wherein the notification: (i) requests the selection of one of the one or more points of interest in recommendation, or (ii) requests permission from the user to add a new point of interest to the map data.

In some instances, the image data includes the image and image metadata, the image metadata including one or more of a name of the image, a date the image was capture, or a location the image was captured.

In some examples, prior to transmitting the image data to the map service, the service analyzes the image, wherein analyzing the image includes using optical character recognition and/or visual recognition algorithms to determine text and/or objects within the image.

In some examples, the image metadata includes the determined text and/or objects within the image.

In some instances, upon receiving the selection of one of the one or more points of interest from a user, the selection is transmitted to the map service.

In some instances, upon receiving permission from the user to add the new point of interest, a new point of interest entry is generated in the map data. In some examples, the system may receive a notification from the map service that data is missing; and request, via one or more notifications on the user device, the user providing the missing data.

### BRIEF DESCRIPTION OF THE DRAWINGS

FIG. 1 is a functional diagram of an example system in accordance with aspects of the disclosure.

FIG. 2 is a pictorial diagram of the example system of FIG. 1.

FIG. 3 is an illustration of the instructions and data within devices of the example system of FIG. 1, in accordance with aspects of the disclosure.

FIG. 4 is a flow diagram 400 that illustrates the process for updating map data maintained by a mapping service with user-generated content in accordance with aspects of the disclosure.

FIG. 5 is an illustration of an example notification querying a user in accordance with aspects of the disclosure.

FIG. 6 is another illustration of an example notification querying a user in accordance with aspects of the disclosure.

FIG. 7 is another illustration of an example notification querying a user in accordance with aspects of the disclosure.

### DETAILED DESCRIPTION

The technology described herein relates to a backend service for updating map data maintained by a mapping service with user-generated content (UGC). For example, a device, such as a mobile phone, may capture and store an image using a camera application. After the image is stored, a backend service executing on the user device may cause a notification microservice also executing on the user device to query whether the user of the device would like to contribute the image to a mapping service. If the user agrees to contribute the image, a map service interface may pass the image data to the mapping service.

The mapping service may process the image data with a machine learning (ML) model. The ML model may generate one of two possible outputs. The first output may include a recommendation of one or more points of interest (POIs) currently in the map data of the mapping service that the image likely corresponds to. The second output may indicate that the ML model did not find any POIs within the map data corresponding to the image. The mapping service may pass the output generated by the ML model to the map service interface.

In the event the ML model provides an output including a recommendation of one or more POIs, the notification microservice may generate a notification requesting the user select or confirm which POI the image corresponds. Based on this selection, the map data of the selected POI may be updated or otherwise supplemented with the image data. If the ML model output indicates that the ML model did not find any matching POIs, the notification microservice may generate a notification inquiring whether the user would like to create a new POI entry within the map data. No further processing will occur if the user does not provide consent to add the captured image to the mapping service.

The technology described herein addresses the problems mentioned above with the known processes for updating or creating map data. For example, the backend system described herein detects when a camera of a user device has captured an image and automatically inquires whether a user would like to contribute the image to update the map data. The automatic inquiry and ease of contributing the image data may encourage more users to provide their images and related data to the map data. In turn, this may lead to improved accuracy and increased population of map data, which may improve the function of the map as an aid for the technical task of user navigation. Moreover, by automatically inquiring whether a user would like to provide the image data, more users may become aware of the ability to supplement the map data, likely increasing the number of users who provide data to the map data. This may lead to further improved accuracy and increased population of map data.

Additionally, the technology described herein avoids the need for a user to proactively navigate to a map application to provide the image to the map data. The reduced effort required by a user to data may increase the amount of image data shared by users to the map data yet further improving the accuracy and increasing the population of map data. Further yet, the backend system described herein provides a guided process to the users. By providing a guided process, the image data provided by the users may be more accurate than found in prior processes. In this regard, the reliance on the ML model to provide POI recommendations corresponding to the image data may reduce the possibility that a user selects an incorrect POI.

The systems, methods, devices, apparatuses, and tangible non-transitory computer-readable media in the disclosed technology each involve an interaction between the user and the navigation system, wherein the navigation system provides real world data using the images of a point of interest and, on the basis of these images, provides other users with information aimed at enabling them to manage the technical task of locating a desired destination in the map in a more reliable manner.

### Example Systems

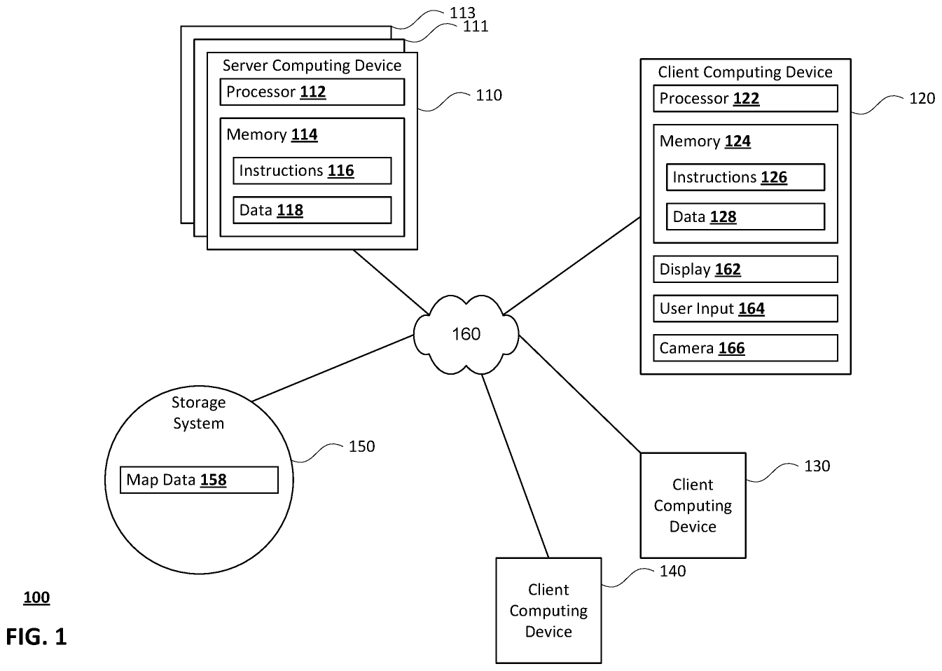

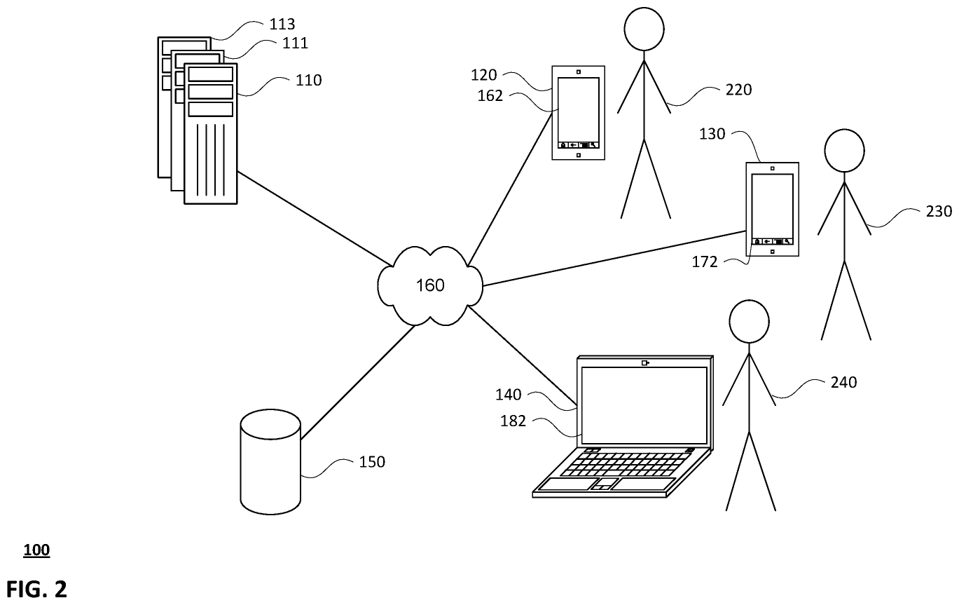

FIGS. 1 and 2 illustrate an example system 100 in which the features described above may be implemented. The system 100 should not be considered as limiting the scope of the disclosure or usefulness of the features described herein. As illustrated, system 100 includes computing devices 110, 111, 113, 120, 130, and 140, and storage system 150. Each computing device, 110, 111, 113, 120, 130, and 140 can contain one or more processors, memory, and other components typically present in general-purpose computing devices. For example, server computing device 110 includes include processor 112 and memory 114. Memory 114 can store information accessible by the processor 112, including instructions 116 that can be executed by the processor 112. Server computing devices 111, 113 may be configured similarly to server computing device 110, although the components within server computing devices 111 and 113 may differ from each other and server computing device 110.

As used herein, the term “computing device” may refer to either “server computing device” or “client computing device,” unless otherwise stated. The terms “server” and “server computing device” may be used interchangeably. Similarly, the terms “client computing device,” “client computer,” and “user device” may be used interchangeably.

Memory 114 can also include data 118 that can be retrieved, manipulated, or stored by the processor. The memory can be of any type, optionally a non-transitory type, capable of storing information accessible by the processor, such as a hard drive, memory card, ROM, RAM, DVD, CD-ROM, write-capable, and read-only memories.

Instructions 116 can be any set of instructions to be executed directly, such as machine code, or indirectly, such as scripts, by the processor 112. In that regard, the terms “instruction,” “application,” “step,” and “program” can be used interchangeably herein. The instructions can be stored in object code format for direct processing by a processor or in any other computing device language, including scripts or collections of independent source code modules that are interpreted on demand or compiled in advance. The functions, methods, and routines of the instructions are explained in more detail below.

Data 118 may be retrieved, stored, or modified by processor 112 in accordance with instructions 116. For instance, although the subject matter described herein is not limited by any particular data structure, the data can be stored in computer registers, in a relational database as a table having many different fields and records, or XML documents. The data can also be formatted in any computing device-readable format such as, but not limited to, binary values, ASCII, or Unicode. Moreover, the data can comprise any information sufficient to identify the relevant information, such as numbers, descriptive text, proprietary codes, pointers, references to data stored in other memories such as at other network locations, or information that is used by a function to calculate the relevant data.

The processor 112 can be any conventional processor, such as a commercially available CPU. Alternatively, the processor can be dedicated components such as an application-specific integrated circuit (“ASIC”) or other hardware-based processors. Server 110 may include any number of processors, although only a single processor is illustrated in FIG. 1. Although not necessary, server 110 may include specialized hardware components, such as hardware accelerators, to perform specific computing processes and functions, such as decoding video, matching video frames with images, distorting videos, encoding distorted videos, machine learning, machine perception, logo recognition, visual text transcription, semantic segmentation, and other such processes and machine learning faster or more efficiently.

Client computing devices 120, 130, and 140 may be configured similarly to the server computing device 110. For instance, client computing device 120 includes processors 122, memory 124, and instructions 126 as described above. Client computing devices 130, 140 may be configured similarly to client computing device 120, although the components within client computing devices 130 and 140 may differ from each other and from client computing device 110.

Client computing devices 120, 130, or 140 may be personal computing devices intended for use by users 220, 230, and 240, respectively, as illustrated in FIG. 2. Each client computing device may have all of the components normally used in connection with a personal computing device. For instance, and as illustrated in FIG. 1, client computing device 120 includes processor 122, which may be a central processing unit (CPU), memory 124 (e.g., RAM and internal hard drives) storing data 128 and instructions 126, a display 162, a user input device 164, and a camera 166. Although client computing device 120 is illustrated with only one processor, display, user input device, and camera in FIG. 1, client computing device 120 may include any number of processors, displays, user input devices, and cameras.

Although the client computing devices 120, 130, and 140 may each comprise a full-sized personal computing device, they may alternatively comprise mobile computing devices capable of wirelessly exchanging data with servers over a network such as the Internet. By way of example only, client computing devices 120 and 130 may be a mobile phone, and client computing device 140 may be a laptop, as illustrated in FIG. 2. In some instances, client computing devices 120, 130, and 140 may be devices such as wireless-enabled PDAs, tablet PCs, netbooks, head-mounted computing systems, wearable devices (e.g., smartwatch,) or any other such computing device.

Displays may be any device operable or otherwise capable of displaying information, such as a monitor having a screen, a touch-screen, a projector, a television, or other such devices. As illustrated in FIG. 2, client computing devices 120 and 130 each include a touch-screen display 162, 172, respectively. The client computing device 140 includes a monitor 182.

User input devices may be any device through which a user can interact with or provide data to a computing device. For instance, user input device 164 of client computing device 120 may be one or more of a mouse, keyboard, keypad, touch-screen, microphone, pen, etc. Client computing device 120 also includes a camera 166, another type of user input device, for recording video streams, capturing images, or both. Although not shown, client computing device 120 may also include speakers, a network interface device, and all of the components used for connecting these elements to one another. Server computing device 110 may also include some or all of the components normally used in connection with a personal computing device.

Although FIG. 1 functionally illustrates the processor, memory, and other elements of computing devices 110 and 120 as being within the same block, respectively, the processor, memory, and other elements can actually comprise multiple processors, memories, or other elements that may or may not be stored within the same physical housing. For example, the memory 114 of server computing device 110 can be a hard drive or other storage media, such as RAM, located in one or more housings different from that of the other components of server computing device 110, such as processors 112. Accordingly, references to a processor, memory, or other elements of the computing devices will be understood to include references to a collection of processors, memories, or elements that may or may not operate in parallel. Moreover, each computing device may be comprised of multiple computing devices. For example, each server computing device 110 may include multiple server computing devices operating as a load-balanced server farm, distributed system, etc. Yet further, although some functions described below are indicated as taking place on a single computing device having a single processor, various aspects of the subject matter described herein can be implemented by a plurality of computing devices working in cooperation by, for example, communicating information over network 160, as described herein.

Each of the server and client computing devices 110, 111, 113, 120, 130, and 140 can be at different nodes of a network 160 and capable of directly and indirectly communicating with other nodes of network 160. Although only computing devices 110, 111, 113, 120, 130, and 140 are depicted in FIGS. 1-2, it should be appreciated that fewer or more computing devices may be possible. In this regard, a typical system can include a large number of connected computing devices, with each different computing device being at a different node of the network 160.

The network 160 and intervening nodes described herein can be interconnected using various protocols and systems, such that the network can be part of the Internet, World Wide Web, intranets, wide area networks, or local networks. The network can utilize standard communications protocols and systems, such as Ethernet, Wi-Fi, Bluetooth, and HTTP, protocols that are proprietary to one or more companies, and various combinations of the foregoing. Although certain advantages are obtained when information is transmitted or received, as noted above, other aspects of the subject matter described herein are not limited to any particular manner of transmission of information.

As an example, each server computing device 110, 111, and 113 may be configured to communicate with storage system 150 as well as client computing devices 120, 130, and 140 via the network 160. For example, one or more server computing devices 110, 111, and 113 may use network 160 to transmit and present information to a user, such as any of users 220, 230, or 240, on a display, such as one of the displays 122, 132, or 142 of computing devices 120, 130, or 140. Although the foregoing example illustrates the server computing devices communicating with client computing devices via network 160, the server computing devices may also communicate with other servicer computing devices. Similarly, client computing devices 120, 130, and 140 may communicate with server computing devices and client computing devices.

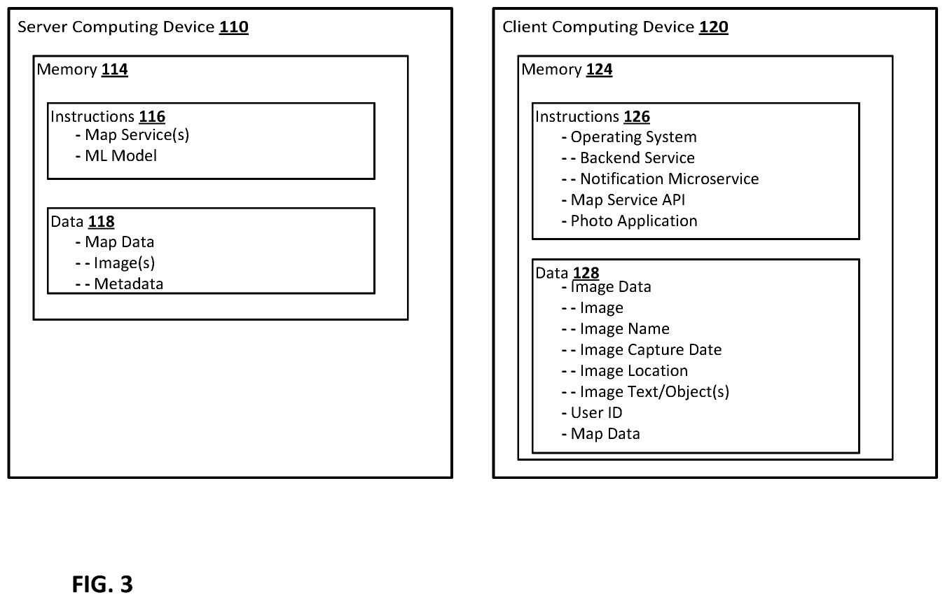

FIG. 3 illustrates example data and instructions that may be stored in the memory of server computing device 110 and client computing device 120. As shown, server computing device 110 includes memory 114 that stores instructions 116, including map services and a machine learning (ML) model, and data 118 that includes map data. The functionality of map services and the ML Model are described further herein.

Map data may include data related to points of interest for retrieval in response to queries for information regarding those POIs, as described herein. In this regard, map data is typically maintained by a mapping service and supplied to users or other applications in response to queries. However, map data may be maintained by any entity, business, individual, or combination thereof and is not limited to mapping services.

As used herein, points of interest may include any place or location. Examples of POIs include businesses, such as restaurants, shops, or service providers such as mechanic auto shops, hotels, gas stations, and electric vehicle charging stations. Additional examples include natural landmarks, parks, public service providers such as police stations or post offices, and civil service locations, such as municipal buildings. Moreover, POIs can include any real-world entity with a physical address, including non-business structures such as residences.

In some instances, a POI can be associated with more than a singular location, such as latitude/longitude coordinates. In this regard, POIs may be associated with many locations or, in some instances, 3D geometry. In this regard, POIs may not be points but may include many locations, such as, for example, a business occupying a building, part of a building, or entire grounds. Further, POIs can be parts of larger, aggregating POIs. For example, each store in a mall may constitute a respective POI, and the mall may be a POI that aggregates each store in the mall.

As illustrated in FIG. 3, map data may include images and metadata. Images within the map data may include photos of POIs, photos of objects and individuals captured at or near the POI, or any other images which may have some association or relation with the POI. For example, photos may include satellite imagery, street-level imagery, and user-provided imagery. As used herein, images may include photographs, screenshots, videos, including video clips and video stills (e.g., frames,) or any other such visual data including actively-lit or passive non-visible band imagery such as LiDAR, radar, or infrared, taken from any perspective, such as ground level, aerial, satellite, etc. In this regard, images may be captured by cameras, video cameras, sensors, such as LiDAR, radar, and infrared sensors, or other such devices.

Metadata within the map data may include any data that may be relevant to one or more points of interest within the map data or other such data that contains information that may be provided, or otherwise referenced, by a map application or other such application that provides map information or services in response to a query. Metadata may also include other data such as information related to images within the map data, virtual tours of locations, business listings, business information, three-dimensional models of locations, real-time navigation, and real-time traffic conditions, amongst other information and services. The metadata may also include data about the images stored in the map data, such as image data including any or all of the date, time, and location the images were captured, the user ID of a user who provided the images, the name of the images, and text/objects identified in the images, as described further herein.

Map data may be stored in any storage structure that allows for images and metadata to be stored in association with a POI. In this regard, image data and metadata may be stored in the same or separate databases as POI entries.

As further illustrated in FIG. 3, the client computing device 120 includes memory 124 that stores instructions 126, including an operating system on which a backend service and notification microservice execute. Instructions 126 also include a photo application for capturing images (e.g., a camera app) and map service API, through which the client computing device 120 may communicate with the map services of server computing device 110.

The backend service and notification microservice may be programs, scripts, etc., that execute on the operating system of the user device. Each of the backend service and the notification microservice are separate and distinct from the map service and photo application. In this regard, the backend service may operate regardless of whether the map service and/or photo application is running concurrently. Moreover, the backend service may communicate with the camera application and/or may operate concurrently with the camera application. Additional functionality of the backend service and notification microservice are described further herein.

Data 128 stored in memory 124 includes image data, user data (e.g., user id(s),) and map data. The image data may include images captured or otherwise stored on a client computing device, as well as information associated with those images, such as the image name, image capture date/time, and the location the image was captured, EXIF data corresponding to the image, or any combination thereof. The location the image was captured may be provided in the form of an address, latitude/longitude coordinates, or any other form of geographical coordinates. As further described herein, the images may be processed using optical character recognition (OCR) and visual recognition algorithms to determine text and objects within the images. The text and objects may be stored in the image data as additional image metadata.

With reference to FIGS. 1 and 2, storage system 150 can be of any type of computerized storage capable of storing information accessible by the server computing devices 110, such as a hard drive, memory card, ROM, RAM, DVD, CD-ROM, write-capable, and read-only memories, or any combination thereof. In addition, storage system 150 may include a distributed storage system where data is stored on a plurality of different storage devices, which may be physically located at the same or different geographic locations. Storage system 150 may be connected to the computing devices via the network 160 as shown in FIG. 1, directly connected to any of the computing devices 110, 111, 113, 120, 130, and 140 (not shown), or some combination of network and direct connections.

Although FIG. 1 illustrates map data 158 as being stored in storage system 150, the map data 158, or other such storage structures, may be stored, in full or in part, in any computing device or other storage system. For instance, client computing device 120 may store a local copy of a portion of map data in the data 128 stored in memory 124, as illustrated in FIG. 3. In another example, server computing device 110 may store a full copy of map data in the data 118 of memory 114, as further illustrated in FIG. 3. Alternatively or additionally, the map data may be stored across multiple computing devices or storage systems. In this regard, portions of map data that make up the entirety of the map data 158 may be stored on different storage devices and/or computing devices. Further, map data 158 may be stored as discrete or integrated portions of a larger database.

### Example Methods

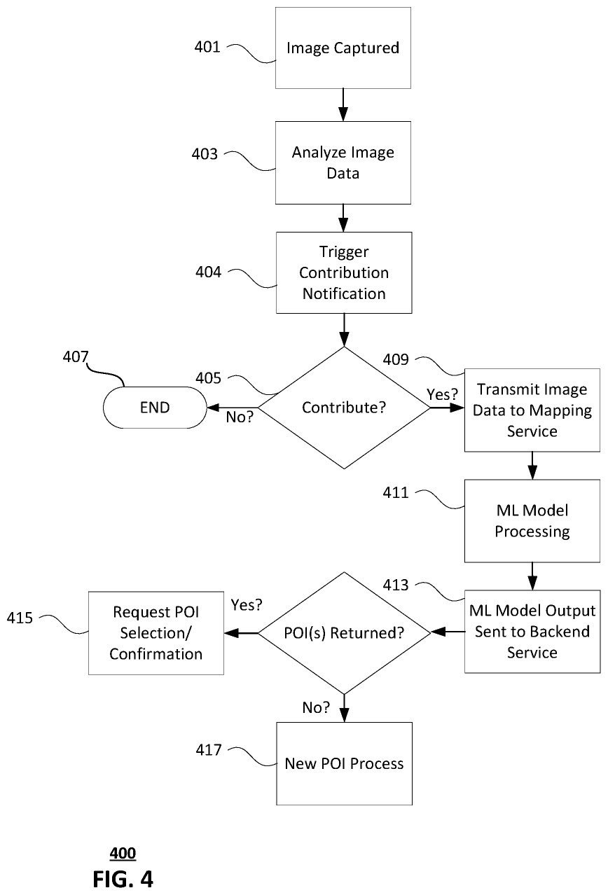

FIG. 4 is a flow diagram 400 that illustrates the process for updating map data maintained by a mapping service with user-generated content. As illustrated in block 401, a user device, such as client computing device 120, may capture an image using a photo application and a camera, such as camera 166. The captured image may be stored in memory 124 on the user device along with corresponding image metadata such as the image name, image capture date and time, the location the image was captured, EXIF data, etc. As used herein, the term image data will be understood to include any or all of the image and image metadata.

The capture of the image may trigger a backend service executing on the user device to analyze the image, as shown in block 403. Analysis of the image by the backend service may include using optical character recognition (OCR) to determine text within the image. Analysis may also include the use of one or more visual recognition algorithms to determine objects within the image. The determined text and objects may be stored in the image data as additional image metadata.

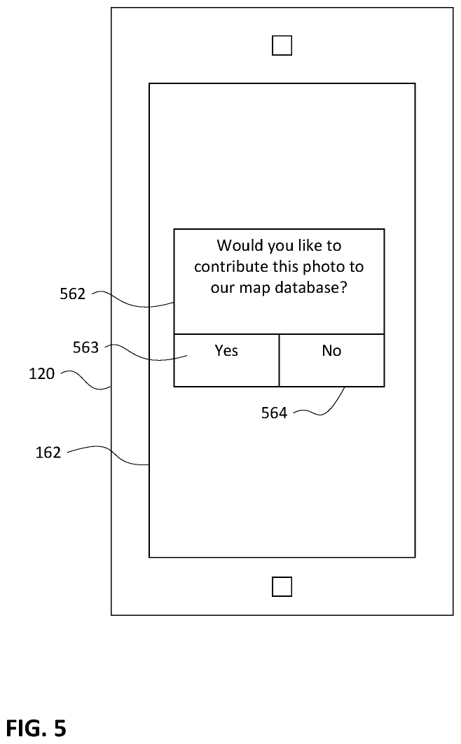

As shown in block 404, the backend service may instruct a notification microservice to query whether the user of the device would like to contribute the image data to a mapping service. For instance, and as illustrated in FIG. 5, after the backend service instructs the notification microservice to query a user, the notification microservice may generate a pop-up notification 562 on the display 162 of the user device 120. Although FIG. 5 illustrates the notification as a pop-up, the notification may be any type of audio or visual notification that can be output by the user device.

In some instances, the backend service may only instruct the notification microservice to query the user when the captured image is determined to be sufficiently associated with a particular place of interest, particular types of places of interest, or captured at a location where additional map data is needed as requested by the mapping service. In this regard, the mapping service may request, via the map service and map service API, a list of places of interest, particular types of places of interest, or locations where map data is needed to the backend service. Upon the capture of an image, the backend service may review the captured image to determine whether it matches one of the places or locations provided by the mapping service. In some instances, the backend service may always instruct the notification microservice to query a user.

The determination of whether an image matches one of the places or locations provided by the mapping service may be made by comparing image data to data corresponding to the places or locations requested by the mapping service. For instance, the backend service may determine whether image data includes location information within a threshold distance of a location requested by the mapping service. If so, the backend service may instruct the notification microservice to query the user to submit the image data.

In another example, the backend service may determine whether the identified text and/or objects within the captured image relate to one of the places or types of places requested by the mapping service. For instance, the mapping service may request only image data corresponding to businesses. As such, if the objects and text identified in the captured image corresponds to, or likely corresponds to, a business, such as a picture of an office building, the backend service may instruct the notification microservice to query the user to submit the image data. Continuing the above example, where the mapping service requests only image data corresponding to businesses, if the objects identified in the captured image relate to a beach, residence, or individual, the backend service may take no further action, and a notification may not be presented to the user.

In the event a notification is presented, the user may select whether or not to contribute some or all of the image data, as shown in block 405 of FIG. 4. In the event the user does not provide consent to add the image to the mapping service, such as by selecting “no” 563 in the pop-up notification 562 in FIG. 5, no further processing would occur, and the process would end, as illustrated by block 407.

In the event the user agrees to contribute the image data, such as by selecting “yes” 564 in the pop-up notification 562, the backend service may transmit the image data to the server computing device via a map service interface as illustrated in block 409.

In some embodiments, the user may select which image data to provide to the mapping service through one or more guided inquiries generated by the backend service through the notification microsystem. User preferences outlining which image data the user selects to share may be stored in a user profile. In such an instance, the backend service may use the user profile to determine which image data the user agrees to share, without the need for the user to identify the image data to share each time the user agrees to contribute image data. In some instances, the user may opt-in to providing the mapping service with identification information, such as a user name, user account name, etc. If the user opts in, this information may be provided to the mapping service in addition to the image data.

The image data received by the mapping service may be processed by the ML model, as illustrated by block 411. The ML model may generate one of two possible outputs. The first output may include a recommendation of one or more points of interest (POIs) currently in the map data of the mapping service that the image likely corresponds. The second output may be an indication that no POIs were found within the map data that correspond with the image.

To generate the two possible outputs, the ML model may pull the existing data from the map data and compare this data with the user-provided image data (i.e., user-generated content). The ML model may then use object recognition and image classification supervised learning techniques to make a determination of which output to provide (e.g., a recommendation of one or more points of interest (POIs) currently in the map data of the mapping service that the image likely corresponds or an indication that no POIs were found within the map data that correspond with the image) The ML model may be trained on the corpus of map data.

To limit the amount of data pulled from the map data by the ML model when determining which output to provide, the ML model may categorize the image data into a particular type of POI, such as a business, school, hospital, park, restaurant, etc. Categorization of the image data may be done using visual recognition algorithms and/or the image data itself. Based on the categorization of the image data to a particular type of POI, the ML model may only pull map data corresponding to that type of POI. Further, the ML model may use other image data, such as the location where the image was captured, to limit the map data pulled by the ML model to only data corresponding to POIs within a particular distance of the location where the image was captured by the user. By limiting the amount of data pulled from the map data, the amount of map data that needs to be processed by the ML model may be decreased relative to processing all of the map data. Accordingly, the ML model may be able to provide output quickly.

The ML model may also compare text data provided in the image data to the map data. For instance, the ML model may determine the text date include a business name and then search for that business in the map data to see if there is a matching POI. In another example, if the text data includes a phone number, the ML model may search for the phone number in the map data to see if it corresponds with an existing POI.

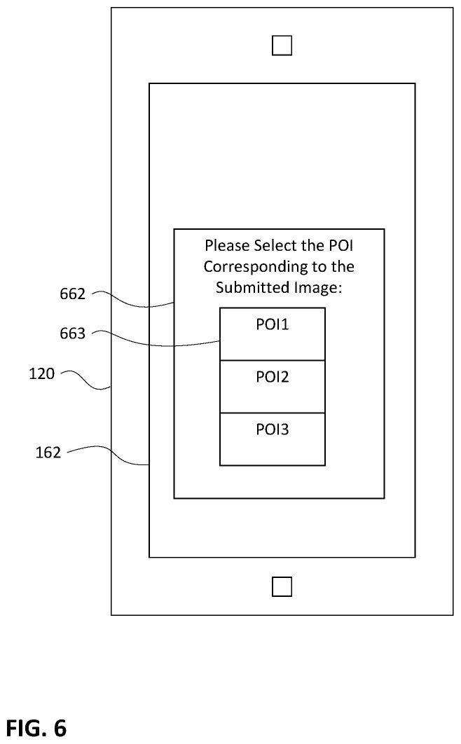

The mapping service may pass the output generated by the ML model to the backend service through the map service interface, as shown in block 413. In the event the ML model provides an output including a recommendation of one or more POIs, the backend service may instruct the notification microservice to generate a notification requesting the user select or confirm which POI the image data corresponds to, as shown in block 415. An example notification 662 provided by the notification microservice is illustrated in FIG. 6. As illustrated, notification 662 is output to the display 162 of the user device 120. Notification 662 includes a listing of POIs 663 from which the user may select the POI that corresponds to the image data provided to the mapping service for entry into the map data. Based on this selection, the image data may be used to update or otherwise supplement the map data of the selected POI may. In some instances, a confirmation that the image data was successfully entered into the map data may be provided to the backend service by the map service via the map service API. The backend service may instruct the notification microservice to provide the confirmation message to the user.

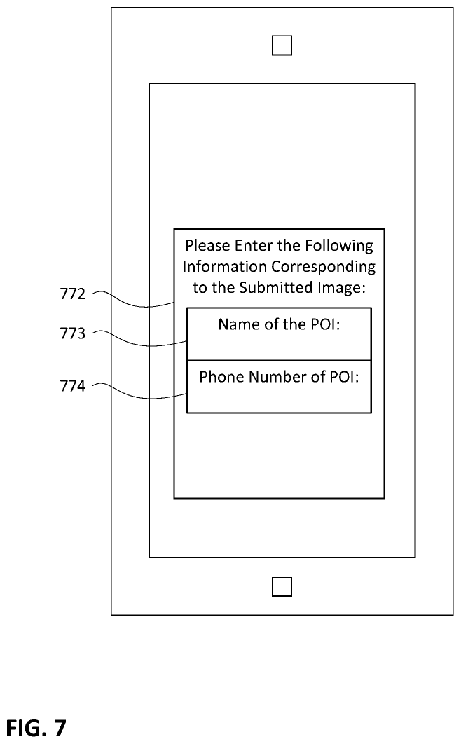

In the event the ML model provides an output indicating that no POIs were found, the notification microservice may generate a notification requesting whether the user would like to create a new POI entry within the map data, as shown in block 417. In the event the user agrees to create a new POI entry, the map service may generate the entry based on the image data and information that can be gleaned from the image data, such as the POI type. For instance, the map service may generate a new entry that includes any or all of the following POI information: name of the POI, the type of POI, the location of the POI (from the image data), the phone number of the POI (included in the text in the image), the website of the POI, the image of the POI, etc. In some instances, some POI information may not be included in or identifiable from the image data. In this instance, the map service may request the user enter this information manually, such as by sending a request to the backend service. Upon receiving the request, the backend service may have the notification microservice generate one or more notifications that request the user provide the necessary information. An example notification 772 requesting the user submit the name 773 and phone number 774 of the POI corresponding to submitted image data is shown in FIG. 7. The backend service may transmit the user inputted data to the map service for use in creating the new POI entry.

In some instances, a confirmation that the image data was successfully entered into a new POI entry in the map data may be provided to the backend service by the map service via the map service API. The backend service may instruct the notification microservice to provide the confirmation message to the user.

Most of the foregoing alternative examples are not mutually exclusive but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. As an example, the preceding operations do not have to be performed in the precise order described above. Rather, various steps can be handled in a different order, such as reversed or simultaneously. Steps can also be omitted unless otherwise stated. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method for updating map data of a mapping service, the method comprising:
capturing, by a computing device, an image of a point of interest, the image including image data;
generating, by a service executing on the computing device, a first notification, the first notification requesting permission to contribute the image data to a map service;
after receiving permission to contribute the image data to the map service, transmitting, by the service, the image data to the map service; and
receiving, by the service from the map service, a recommendation, wherein the recommendation includes:
(i) one or more points of interest, in the map data, to which the image data corresponds, or
(ii) an indication that no points of interest that correspond with the image data were found within the map data.

2. The method of claim 1, further comprising:
generating, by the service, a second notification, wherein the second notification:
(i) requests the selection of one of the one or more points of interest in the recommendation, or
(ii) requests permission from the user to add a new point of interest to the map data.

3. The method of claim 1, wherein the image data includes the image and image metadata, the image metadata including one or more of a name of the image, a date the image was captured, or a location the image was captured.

4. The method of claim 1, further comprising:
prior to transmitting the image data to the map service, analyzing, by the service the image, wherein analyzing the image includes using optical character recognition and/or visual recognition algorithms to determine text and/or objects within the image.

5. The method of claim 4, wherein the image metadata includes the determined text and/or objects within the image.

6. The method of claim 1, further comprising:
upon receiving the selection of one of the one or more points of interest from a user, transmitting the selection to the map service.

7. The method of claim 1, further comprising:
upon receiving permission from the user to add the new point of interest, generating a new point of interest entry in the map data.

8. The method of claim 7, further comprising:
receiving, by the service, a third notification from the map service indicating that data is missing; and
requesting, via one or more fourth notifications on the user device, the user providing the missing data.

9. A system, comprising:
one or more processors configured to:
capture an image of a point of interest, the image including image data;
generate, by a service, a first notification, the first notification requesting permission to contribute the image data to a map service;
after receiving permission to contribute the image data to the map service, transmit by the service, the image data to the map service; and
receive, by the service from the map service, a recommendation, wherein the recommendation includes:
(i) one or more points of interest, in the map data, to which the image data corresponds, or
(ii) an indication that no points of interest that correspond with the image data were found within the map data.

10. The system of claim 9, wherein the one or more processors are further configured to:
generate, by the service, a second notification, wherein the second notification:
(i) requests the selection of one of the one or more points of interest in recommendation, or
(ii) requests permission from the user to add a new point of interest to the map data.

11. The system of claim 9, wherein the image data includes the image and image metadata, the image metadata including one or more of a name of the image, a date the image was captured, or a location the image was captured.

12. The system of claim 9, wherein the one or more processors are further configured to:
prior to transmitting the image data to the map service, analyze, by the service the image, wherein analyzing the image includes using optical character recognition and/or visual recognition algorithms to determine text and/or objects within the image.

13. The system of claim 12, wherein the image metadata includes the determined text and/or objects within the image.

14. The system of claim 9, wherein the one or more processors are further configured to:
upon receiving the selection of one of the one or more points of interest from a user, transmit the selection to the map service.

15. The system of claim 9, wherein the one or more processors are further configured to:
upon receiving permission from the user to add the new point of interest, generate a new point of interest entry in the map data.

16. The system of claim 15, wherein the one or more processors are further configured to:
receive, by the system, a third notification from the map service indicating that data is missing; and
request, via one or more fourth notifications on the user device, the user providing the missing data.

17. A non-transitory computer-readable storage medium storing instructions executable by one or more processors for performing a method, the method comprising:
capturing an image of a point of interest, the image including image data;
generating, by a service, a first notification, the first notification requesting permission to contribute the image data to a map service;
after receiving permission to contribute the image data to the map service, transmitting by the service, the image data to the map service; and
receiving, by the service from the map service, a recommendation, wherein the recommendation includes:
(i) one or more points of interest, in the map data, to which the image data corresponds, or
(ii) an indication that no points of interest that correspond with the image data were found within the map data.

18. The non-transitory computer readable medium of claim 17, wherein the method further comprises:
generating, by the service, a second notification, wherein the second notification:
(i) requests the selection of one of the one or more points of interest in recommendation, or
(ii) requests permission from the user to add a new point of interest to the map data.

19. The non-transitory computer readable medium of claim 17, wherein the image data includes the image and image metadata, the image metadata including one or more of a name of the image, a date the image was captured, or a location the image was captured.

20. The non-transitory computer readable medium of claim 17, wherein the method further comprises:
prior to transmitting the image data to the map service, analyzing, by the service the image, wherein analyzing the image includes using optical character recognition and/or visual recognition algorithms to determine text and/or objects within the image.
